(19) United States
(12) Patent Application Publication
(10) Pub. No.: US 2010/0057405 A1
(43) Pub. Date: Mar. 4, 2010

(54) AUTOMATED SOFTWARE TESTING ENVIRONMENT

(75) Inventor: Max Wu, San Diego, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, NJ (US)

(21) Appl. No.: 12/200,541

(22) Filed: Aug. 28, 2008

(51) Int. Cl. G06F 17/40

(52) U.S. Cl. 702/187

(57) ABSTRACT

A computer controlled system of capturing and replaying test information. The system may comprise a device under test (DUT), e.g., a television set, a recording device, e.g., a camera, a memory component and a processor. The DUT receives test signals and responsive thereto generates a plurality of output responses. The recording device captures renderable output responses, e.g., image, audio, etc., of the plurality of output responses. The memory component stores the plurality of output responses. Non-renderable output responses are captured and stored in memory. Storing the responses may be responsive to a triggering event, e.g., detection of a new device. The processor may analyze data by correlating testing signals, renderable output responses and non-renderable output responses. The plurality of testing signals may be provided from a pre-programmed test script via a remote control. The plurality of testing signals and the plurality of output responses may be time coded and tagged.

### TECHNICAL FIELD

Embodiments of the present invention relate to the field of electronics. More particularly, embodiments of the present invention relate to automatic testing of electronic devices.

### BACKGROUND ART

In general, electronic devices are tested for integrity and functionality prior to customer release. For example, various functionalities of an electronic device may be thoroughly and independently tested to ensure integrity prior to its release to consumers.

Television sets have become common items in most households. Various technologies may be used to manufacture television sets, e.g., plasma technology, liquid crystal display technology (LCD), light emitting diode (LED) technology, projection television technology, etc. Similar to other electronic devices, television sets are tested prior to their use by consumers.

Testers employ various methods to capture the result of a given test in order to enable developers to duplicate the test result in an effort to remedy a detected problem or a defect. For example, in one conventional method a tester may take a picture of the device under test when a defect or a problem has been encountered and detected. Alternatively, a tester may manually video tape the device under test during testing. In one conventional method, a test person may manually write down the description of the problem/defect. Unfortunately, these steps are manual by nature and time consuming.

When test people perform the manual steps discussed above, the test person forms a judgment as to the potential cause of the detected problem and defect. Therefore, the suspected problem/defect is determined from the tester's perspective. The tester's perspective usually does not aid developers in pinpointing the technical source of the problem/defect since the tester's perspective is generally non-technical in nature. For example, a tester may note a problem regarding a portion of the screen that displays a graphical element. However, a noted problem/defect in displaying a graphical element on a portion of a display does not provide developers with full technical information needed to troubleshoot the defective unit, e.g., the state of the processor, the contents of memory, etc., that coincide with this problem/defect.

Moreover, reliance on the tester's perspective does not guarantee that the problem/defect can be duplicated. For example, the problem/defect may have occurred in a portion of the device under test that is different from the portion that the tester has specified as being problematic. Thus, it is difficult to pinpoint and therefore remedy a problem/defect that cannot be duplicated.

In one conventional test method, developers may rely on log files generated during testing procedures to duplicate defects. However, relying on log files alone may not be sufficient to duplicate the defect. For example, many defects occur infrequently, e.g., once in every one hundred times. As a result, relying on lengthy log files to duplicate defects becomes inefficient due to the large volume of data that needs to be processed.

Conventional testing methods are time consuming and manually intensive. Furthermore, conventional testing methods fail to guarantee that a detected problem/defect can be duplicated in a timely fashion by developers, thereby allowing them to pinpoint the cause of the detected defect/problem.

### SUMMARY

Accordingly, a need has arisen for a testing system that allows developers to more readily duplicate a detected problem/defect that occurred during product testing in a timely fashion. Moreover, a further need has arisen to enable developers to better pinpoint the cause of a detected defect/problem in order to address the defect. It will become apparent to those skilled in the art in view of the detailed description that the embodiments of the present invention remedy the above mentioned needs.

In one embodiment of the present invention, the test results of a device under test (DUT), e.g., a television set, are captured. During testing, a plurality of testing signals may be applied to the DUT. As a result, the DUT may generate a plurality of output responses. It is appreciated that output responses may be renderable and/or non-renderable in nature. For example, in response to a testing signal to display a specific graphical object, the DUT may output a response, e.g., a graphical image and an electronic signal. The displayed graphical image is a renderable response while the electronic signal is a non-renderable output. Output responses from the DUT may be captured and stored in a memory component.

In one exemplary embodiment, a video recording device may be used to capture renderable output responses from the DUT and these images may be supplied to a computer system in digital form. The recorder may be a camera, a video camera, a web camera, etc. In one exemplary embodiment, the renderable output may be a graphical element, e.g., text, image, color, etc., output from the DUT, e.g., a display device. Renderable output may also be an audio output. It is appreciated that the recorded renderable outputs may be stored in a digital memory component. In this embodiment, the computer system may also record the non-renderable outputs from the DUT to the memory component. Moreover, the computer system may also record the testing signals applied to the DUT.

It is appreciated that in one exemplary embodiment, the recorded plurality of testing signals may be tagged with time codes. Similarly, it is appreciated that the plurality of recorded output responses may be time coded. For example, the recorded renderable output responses and/or non-renderable output responses may be time coded.

In one exemplary embodiment, the plurality of testing signals may originate from a preprogrammed test script. The plurality of testing signals may also be provided to the DUT using a remote control device that is infrared signal enabled and controlled by the computer system.

According to one embodiment, the plurality of output responses, that may include renderable and/or non-renderable output responses from the DUT, may be recorded and stored responsive to a triggering event. For example, in response to detecting an error and/or problem associated with the DUT, renderable output responses from the DUT may be stored in the memory component. Similarly, non-renderable output responses from the DUT may be stored in the memory component responsive to detecting an error associated with the DUT. It is appreciated that the triggering event may be any event, e.g., a user initiation of the testing process, detection of a new device, etc. It is appreciated that the memory component that stores renderable output responses and the memory component that stores non-renderable output responses may be the same or a different memory component.

The collected information from the DUT may be processed by a processor, e.g., of the computer system. For example, in one embodiment renderable output responses and non-renderable output responses may be time stamped and correlated to one another. It is further appreciated that the plurality of testing signals (commands) may also be time stamped and correlated to the output responses that are time stamped. Thus, the time stamped information may be used by developers for quick reference, e.g., playback, in determining the product behavior, e.g., inputs (commands) and output responses for any given time.

As a result of the testing system and methodology described herein, developers are provided with information about the state which the DUT had at the time that a problem occurred. Moreover, developers are provided with visual observations as to what they would have observed had they been present when the problem occurred. As such, developers may more readily duplicate the problem/defect in a timely fashion in comparison to the conventional methods.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an exemplary testing system in accordance with one embodiment of the present invention.

FIG. 2 shows a flow diagram of a testing methodology in accordance with one embodiment of the present invention.

FIG. 3 shows a flow diagram for replaying test information in accordance with one embodiment of the present invention.

FIG. 4 illustrates a general purpose computer system that may serve as a platform for embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “storing” or “triggering” or “capturing” or “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Automated Software Testing Environment

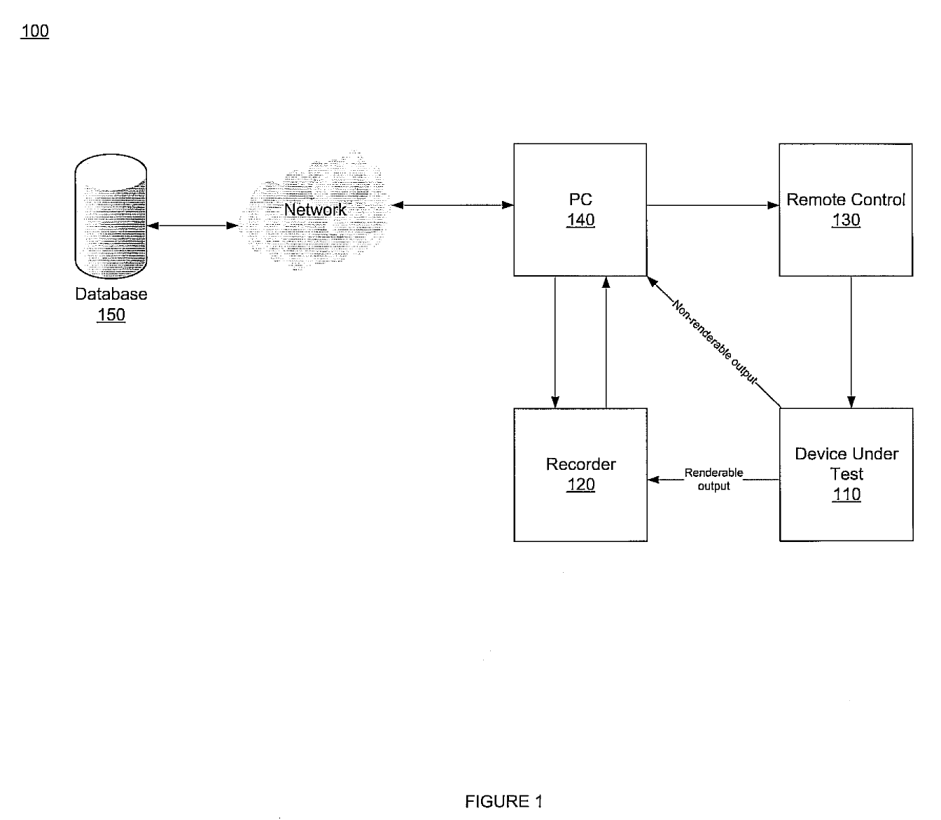

Referring now to FIG. 1, an exemplary testing system 100 in accordance with one embodiment of the present invention is shown. The exemplary testing system 100 comprises a device under test 110, a recording device 120, a remote control device 130 and a computer system controller, e.g., a personal computer (PC) 140. It is appreciated that the PC 140 may be coupled to a database 150 via a network, e.g., wireless network, wired network, fiber optic network, etc. The remote control device 130 controls the DUT 110 and may be a wired or a wireless control device. If wireless, the remote control 130 may be via infrared (IR) or radio frequency (RF) technology.

According to one embodiment, the database 150 includes a disk drive storage system and may provide preprogrammed test scripts for application to the DUT 110 via the PC 140 and the remote control 130. For example, the PC 140 may be coupled to the database 150 via the network. Preprogrammed test scripts may be accessed by the PC 140 and supplied to the remote control 130 for application to the DUT 110. Test scripts may comprise testing signals to be applied to the DUT 110 under various conditions and circumstances. The preprogrammed test scripts may be time stamped based on when the testing signals are applied to the DUT 110. These time stamped input signals may be recorded.

The DUT 110 may be any electronic device such as a television set capable of receiving commands, e.g., testing signals. For example, one testing signal may test the DUT 110 response to a frame request while another testing signal may detect the speed at which the frame is being refreshed. Similarly, another testing signal may test the brightness of a particular pixel of the television set.

According to one embodiment, the PC 140 provides the stored and time stamped test script to the remote control device 130. The remote control device 130 in turn provides the test script to the DUT 110 as a plurality of testing commands. In one embodiment, the remote control device 130 utilizes infrared signaling to communicate with the DUT 110. It is appreciated that other technologies, e.g., RF technology, may be used to communicate with the DUT 110. In one example, a keyboard, a touch screen, a voice recognition command, etc., may be used to provide testing signals to the DUT 110. As such, the use of remote control device 130 is exemplary and should not be construed as limiting the scope of the present invention.

The DUT 110 may generate or output a plurality of responses that are responsive to the applied testing signals. It is appreciated that the output responses may be renderable outputs, e.g., a graphical image, audio output, etc., and/or non-renderable outputs, e.g., an electronic signal having a value, the value of a register, the address of data in a register, etc.

As discussed, the recording device 120 may be controlled by the PC 140 and is operable to capture renderable output responses by the DUT 110, e.g., user interface items such as graphical images, frames, pixels, audio output, etc. In particular, the recording device 120 may be a digital camera, a video camera, a web camera, a speaker, a microphone, etc. The captured renderable output responses may be digitized and stored in a memory component that may reside within the PC 140. It is appreciated, however, that the memory component may be a standalone memory component and may reside outside of the PC 140. For example, the PC 140 may store the renderable output responses in the database 150.

It is appreciated that according to one embodiment, non-renderable output responses from the DUT 110 may also be captured and stored in digital form. For example, non-renderable output responses may include information such as electrical signals, software codes and/or their corresponding states, register states, etc., that may generate renderable output responses. It is appreciated that the non-renderable output responses may be captured by the PC 140 and stored in a digital memory component therein. It is noted that the memory component which stores the non-renderable output responses may be the same memory component that stores renderable output responses. Furthermore, it is appreciated that the memory component that stores non-renderable output responses may be a standalone memory component and may reside outside of the PC 140. For example, the PC 140 may store the non-renderable output responses in the database 150.

Thus, renderable output responses as well as internal state information of the DUT 110 that may relate to the renderable output responses are captured and stored. In accordance with embodiments of the present invention, the captured and stored information may be used by developers to duplicate and understand the cause of a particular defect/problem in a timely fashion relative to conventional methods.

It is appreciated that according to one embodiment, the plurality of testing signals are tagged by the PC 140 with time stamps of when they are applied to the DUT 110. Similarly, in one exemplary embodiment, the output responses from the DUT 110 that are responsive to the plurality of testing signals, e.g., renderable and non-renderable responses, are also tagged with time stamps by the PC 140 at the time of capturing and storing. For example, the output responses captured by the recorder device 120 may be time stamped by the PC 140. It is appreciated that the output responses, e.g., renderable output responses such as recorded audio/video may be digitized by the PC 140 after being captured by the recording device 120 prior to their storage.

Output responses from the DUT 110 may be co-processed. For example, various renderable output responses may be correlated with related non-renderable output responses, e.g., a state of a particular register.

Thus, with this data, developers can view the DUT at the time that a problem occurred by replaying the recorded video. For example, developers may view renderable responses when a problem occurred along with a display of the non-renderable responses, e.g., the internal state of the DUT, at the time that the problem occurred. Internal state data may be displayed as a table on the computer system 140. In other words, time stamps may be used to correlate the renderable and non-renderable responses. Similarly, the testing signals that may be provided by a remote control device 130 as commands, may be correlated with the output responses, e.g., renderable and non-renderable responses, in a similar manner at the time that the problem occurred.

In one embodiment, a graphical user interface (GUI) may be used to display response and test information. For example, a graphical window on the PC 140 may be used to display the renderable responses at the time that a problem occurred. In one embodiment, a separate graphical window or the same graphical window on the PC 140 may be used to display the non-renderable responses at the time that the problem occurred. Moreover, the GUI may be used to simultaneously display the testing signals. As such, the time stamps may be used to correlate the renderable responses to the non-renderable responses. Furthermore, the time stamps may be used to correlate the output responses to the testing signals, e.g., commands, in order to detect the behavior of the DUT 110 at any time. Thus, a problem may be duplicated by replaying the time stamped commands at the time that the problem occurred along with a replay of the renderable and non-renderable responses, e.g., internal state data of the DUT, at the time that the problem occurred.

It is appreciated that various components of the system 100 may be coupled to one another via a wired connection and/or a wireless connection. It is further appreciated that the recording and the storing of output responses may be done responsive to a triggering event. For example, when no problem has been detected, no information may be stored. On the other hand, when a problem is detected, testing signals and output responses may be contemporaneously stored, e.g., renderable output response captured by the recording device 120 and/or non-renderable output responses. It is appreciated that the triggering event may be any event. For example, the triggering event may be a user initiated event. Similarly, the triggering event may be a detection of a new device being connected to the system 100. Thus, examples for the triggering event described above are not intended to limit the scope of the present invention.

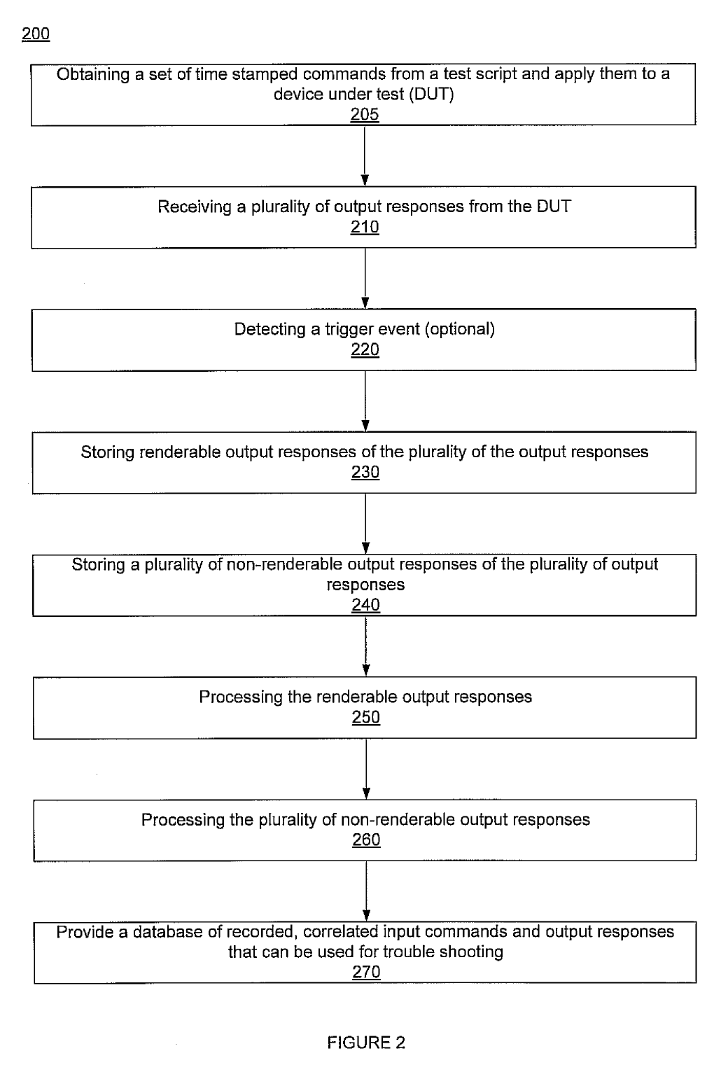

Referring now to FIG. 2, a flow diagram 200 of a testing methodology in accordance with one embodiment of the present invention is shown. At step 205, a set of commands from a test script is obtained by the PC 140 and applied to the DUT 110. For example, the test script may be transmitted by the database 150 and received and stored by the PC 140. Before applying testing signals to the DUT 110, the test script is read by a computer system, e.g., the PC 140. The testing signals are sent to the remote control device 130 for transmission to the DUT 110. In one exemplary embodiment, a remote control device 130 that is infrared or RF enabled may be used to provide the plurality of testing signals to the DUT 110. These signals are time stamped and recorded at the computer system, e.g., the PC 140, before their application to the DUT 110. The remote control device 130 may then apply the testing signals as commands to the DUT 110.

At step 210, a plurality of output responses may be received from the DUT 110. The plurality of output responses are responsive to the plurality of testing signals. It is appreciated that the plurality of output responses may comprise renderable and non-renderable output responses. The renderable output responses may be captured by the recording device 120 and likewise may be time stamped during capturing. Similarly, the non-renderable output may be captured and time stamped by the computer system, e.g., the PC 140.

At step 220, a triggering event may be optionally detected. For example, the triggering event may be responsive to a user initiation of the testing procedure, a detection of a problem, detection that a new device has been connected, etc. The detected trigger event may cause the plurality of captured output responses to be stored into a memory component.

At step 230, the captured and time stamped renderable output responses of the DUT 110 captured by the recording device 120, e.g., camera, may be stored. It is appreciated that the storing may be responsive to the triggering event at step 220. At step 240, time stamped non-renderable output responses may similarly be stored in a memory component. It is similarly appreciated that the storing of non-renderable responses may be responsive the detection of the triggering event at step 220. The output responses including renderable and non-renderable portions may be stored under control of a computer system, e.g., the PC 140.

At step 250, renderable output responses may be processed by the PC 140. Similarly at step 260, non-renderable responses may be processed by the PC 140. According to one exemplary embodiment, the processing may comprise correlating the renderable output responses to the non-renderable responses using their corresponding time stamps. It is appreciated that the non-renderable output responses may be related to the renderable output responses, e.g., state of a register, address of a data on a register, etc. It is further appreciated that the input commands that are time stamped may also be correlated to the output responses, e.g., renderable and non-renderable output responses at step 260.

At step 270, correlated input commands and output responses that can be used for trouble shooting are provided within a database. For example, the correlated input commands and output responses may be provided and stored in a database, e.g., database 150.

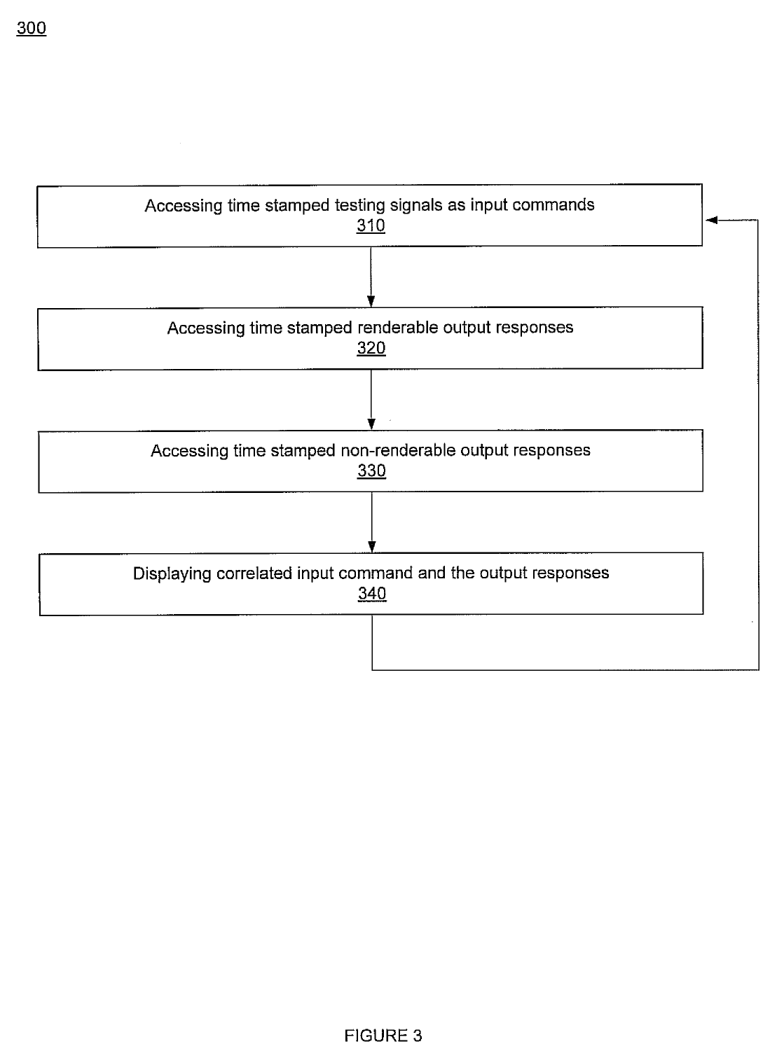

Referring now to FIG. 3, a flow diagram 300 for replaying test information in accordance with one embodiment of the present invention is shown. At step 310, testing signals that are time stamped and supplied as commands to the DUT 110 are accessed for a given time that is associated with a defect or problem.

At step 320, the time stamped renderable output responses for the given time are accessed. It is appreciated that the time stamped renderable output responses may have been processed and correlated to the non-renderable output responses and the testing signals before being accessed from memory.

Similarly, at step 330 the time stamped non-renderable output responses are accessed for the given time. It is appreciated that the time stamped non-renderable output responses may have been processed and correlated to the renderable output responses and the testing signals before being accessed from memory.

At step 340, correlated output responses, e.g., renderable and non-renderable output responses, with correlated input commands may be displayed for the given time. For example, a graphical user interface (GUI) on PC 140 may be used to display renderable responses at the time that a problem occurred in a first graphical window. Similarly, the GUI may be used to display non-renderable responses at the time that the problem occurred in the first graphical window or a separate graphical window. The input commands that caused the renderable and non-renderable responses at the time that the problem occurred may also be displayed in the GUI in the first graphical window or a separate graphical window. This process repeats until the pertinent captured and stored information during testing is replayed by the developer.

As such, developers may now step through the testing process in a chronological manner. Thus, the input commands and output responses, e.g., renderable and non-renderable output responses, to the input commands may now be examined in a chronological fashion effectively replaying the testing environment of the DUT 110.

Accordingly, renderable output responses as well as non-renderable output responses that may have caused a problem during testing are captured. Correlation of various input commands and responses provides testers with visibility as to the renderable and non-renderable portion of output responses that may have led to the detected problem. As such, developers may now duplicate and replay the detected problem and work toward remedying the defect in a timely fashion.

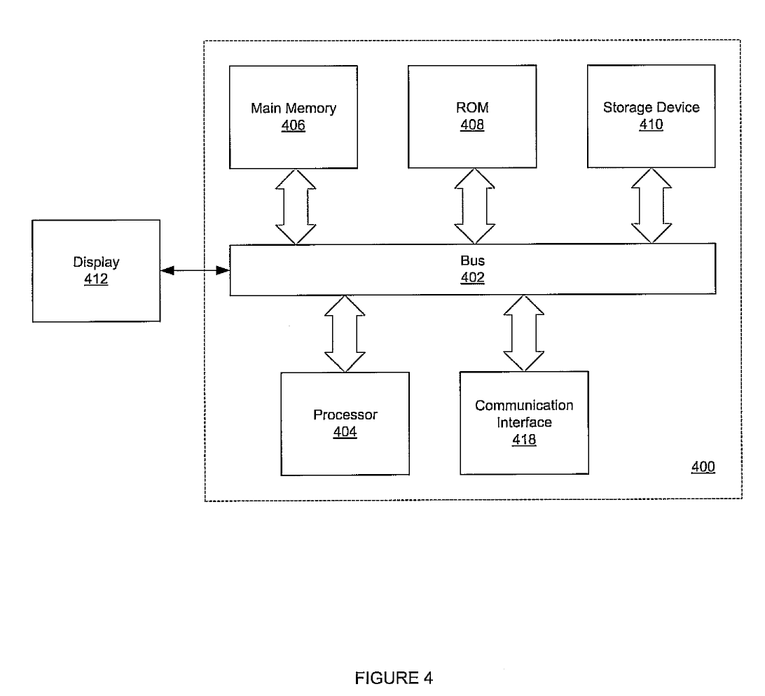

FIG. 4 is a block diagram that illustrates a computer system 400 upon which embodiments of the invention may be implemented. Computer system 400 may implement the process for capturing and replaying testing information as described above in conjunction with FIGS. 1 through 3. The computer system 400 may include a bus 402 or other communication mechanism for communicating information, and a processor 404 coupled with bus 402 for processing information.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A non-volatile storage device 410, such as a magnetic disk or optical disk, is provided and coupled to bus 402 for storing information and instructions and may store the persistent internal queue. According to one embodiment, the instructions for implementing the virtual device may be stored on any one of the memory components (e.g., RAM, ROM, non-volatile storage device and etc.). Computer system 400 may be coupled via bus 402 to an optional display 412, such as a cathode ray tube (CRT), for displaying information to a computer user.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system of capturing testing information comprising:
a device under test (DUT) operable to receive a plurality of test signals and responsive thereto operable to generate a plurality of output responses;
a recording device operable to capture renderable output responses of said plurality of output responses generated by said DUT;
a memory component operable to store said plurality of output responses from said DUT, wherein said plurality of output responses comprises said renderable output responses and non-renderable output responses; and
a processor coupled to said memory and operable to correlate renderable output responses to non-renderable output responses.

2. The system as described in claim 1, wherein said plurality of test signals is provided by a pre-programmed test script and wherein further said memory component is operable to store time stamped test signals.

3. The system as described in claim 1, wherein said DUT is a television set and wherein said recording device is a video recorder.

4. The system as described in claim 1, wherein said plurality of output responses are time coded.

5. The system as described in claim 1, wherein said renderable output responses comprise graphical images.

6. The system as described in claim 1 further comprising:
a remote control operable to send said plurality of test signals and wherein said memory component is operable to store said plurality of test signals.

7. The system as described in claim 6, wherein said plurality of test signals are time coded.

8. The system as described in claim 6, wherein said memory component stores said plurality of output responses, said renderable output and said plurality of test signals responsive to a triggering event.

9. A method of capturing test information comprising:
receiving a plurality of output responses from a device under test (DUT), wherein said plurality of output responses is responsive to an application of a plurality of test signals to said DUT;
capturing and storing renderable output responses of said plurality of said output responses;
capturing and storing a plurality of non-renderable output responses of said plurality of output responses; and
processing said renderable output responses and further processing said plurality of non-renderable output responses, wherein said processing comprises correlating said renderable output responses to said plurality of non-renderable output responses.

10. The method as described in claim 9 further comprising applying said plurality of testing signals to said DUT wherein said plurality of testing signals are accessed from a pre-programmed test script.

11. The method as described in claim 9, wherein said DUT is a television set.

12. The method as described in claim 9 further comprising time coding said plurality of output responses.

13. The method as described in claim 12, wherein said plurality of test signals are time coded and also provided by a remote control and further comprising storing said plurality of test signals.

14. The method as described in claim 9 further comprising:
detecting a trigger event, wherein said storing said renderable output responses and said storing said plurality of non-renderable output responses are both responsive to said trigger event.

15. A computer-useable medium having computer-readable program code stored thereon for causing a computer system to execute a method of capturing test information, said method comprising:
controlling the application of a plurality of test signals to a device under test (DUT);
receiving a plurality of output responses from said DUT, wherein said plurality of output responses is responsive to said plurality of test signals;
capturing and storing a plurality of renderable output responses of said plurality of output responses;
capturing and storing a plurality of non-renderable output responses of said plurality of output responses; and
processing said plurality of renderable output responses and further processing said plurality of non-renderable output responses, wherein said processing comprises correlating said plurality of renderable output responses to said plurality of non-renderable output responses.

16. The computer-useable medium as described in claim 15, wherein said plurality of testing signals is accessed from a pre-programmed test script.

17. The computer-useable medium as described in claim 15, wherein said DUT is a television set.

18. The computer-useable medium as described in claim 15 wherein said method further comprises time coding said plurality of output responses.

19. The computer-useable medium as described in claim 18, wherein said plurality of test signals are time coded and also provided by a remote control and wherein said method further comprises storing said plurality of test signals.

20. The computer-useable medium as described in claim 15 wherein said method further comprises:
detecting a trigger event, wherein said capturing and storing are responsive to said trigger event.
